(19) United States
(12) Patent Application Publication
(10) Pub. No.: US 2024/0139916 A1
(43) Pub. Date: May 2, 2024

(54) IMPACT TOOL INCLUDING AN ELECTRONIC CLUTCH

(71) Applicant: MILWAUKEE ELECTRIC TOOL CORPORATION, Brookfield, WI (US)

(72) Inventors: Amith Joshua Baskaran, Menomonee, WI (US); Kentez Lanier Craig, Milwaukee, WI (US); Mitchell Gavin Menard, Chicago, IL (US)

(21) Appl. No.: 18/498,846

(22) Filed: Oct. 31, 2023

Related U.S. Application Data
(60) Provisional application No. 63/381,820, filed on Nov. 1, 2022.

(51) Int. Cl. B25B 21/02; B25D 16/00

(52) U.S. Cl. CPC B25B 21/026; B25D 16/003; B25D 16/006; B25D 2250/165; B25D 2250/221

(57) ABSTRACT

A power tool including a hammer, an anvil, and a spring having a stiffness indicating a trip torque value. A mode selection mechanism is configured to select between an electronic clutch mode and an impact mode. The electronic clutch mode includes an electronic clutch threshold that is less than a trip torque value. A load sensor is connected to the motor. The load sensor is configured to detect a load of the motor. A controller is connected to the mode selection mechanism, the current sensor, and the motor. The controller is configured to receive a mode selection signal from the mode selection mechanism, drive the motor in response to the mode selection signal, receive a load signal from the load sensor related to the load of the motor, and activate the electronic clutch when the load of the motor is greater than the electronic clutch threshold.

### RELATED APPLICATIONS

This application claims the benefit of U.S. Provisional Patent Application No. 63/381,820, filed Nov. 1, 2022, the entire content of which is hereby incorporated by reference.

### FIELD

Embodiments described herein relate to control of a motor within a power tool.

### SUMMARY

Embodiments described herein provide techniques for control of a power tool using an electronic clutch. For example, a power tool includes a motor, an impact mechanism including a hammer driven by the motor, an anvil configured to receive an impact from the hammer, and a spring within the impact mechanism. The spring has a stiffness related to a trip torque value of the impact mechanism, and the spring is configured to axially bias the hammer to engage the anvil. The power tool also includes a mode selection mechanism configured to select between a first mode (e.g., an electronic clutch mode) and a second mode (e.g., an impact mode). The electronic clutch mode includes an electronic clutch threshold for activating an electronic clutch, the electronic clutch threshold is less than the trip torque value of the impact mechanism. The power tool also includes a current sensor electrically connected to the motor. The current sensor is configured to detect a current of the motor. The power tool also includes a controller connected to the mode selection mechanism, the current sensor, and the motor. The controller is configured to receive a mode selection signal from the mode selection mechanism, and drive, in response to the mode selection signal indicating the electronic clutch mode, the motor based on the electronic clutch threshold. The controller is further configured to receive a current signal from the current sensor related to the current of the motor and activate the electronic clutch when the current of the motor is greater than the electronic clutch threshold.

Power tool described herein include a motor, an impact mechanism, a mode selection mechanism, a load sensor, and a controller. The impact mechanism is coupled to the motor. The impact mechanism includes a hammer driven by the motor, an anvil configured to receive an impact from the hammer, and a spring within the impact mechanism. The spring is configured to axially bias the hammer to engage the anvil. The spring has a spring stiffness related to a trip torque value of the impact mechanism. The mode selection mechanism is configured to select between an electronic clutch mode and an impact mode. The electronic clutch mode includes an electronic clutch threshold for activating an electronic clutch. The electronic clutch threshold is less than the trip torque value of the impact mechanism. The load sensor is configured to detect a load of the motor. The controller is connected to the mode selection mechanism, the load sensor, and the motor. The controller is configured to receive a mode selection signal from the mode selection mechanism, drive, in response to the mode selection signal indicating the electronic clutch mode, the motor based on the electronic clutch threshold, receive a load signal from the load sensor related to a load of the motor, and activate the electronic clutch when the load of the motor is greater than or equal to the electronic clutch threshold.

Power tools described herein include a motor, an impact mechanism, a mode selection mechanism, a load sensor, and a controller. The impact mechanism is coupled to the motor. The impact mechanism includes a hammer driven by the motor, an anvil configured to receive an impact from the hammer, and a spring within the impact mechanism. The spring is configured to axially bias the hammer to engage the anvil. The impact mechanism includes a trip torque value. The mode selection mechanism is configured to select a between a first clutch threshold and a second clutch threshold. The first clutch threshold is less than the trip torque value and the second clutch threshold is greater than the trip torque value. The load sensor is configured to detect a load of the motor. The controller is connected to the mode selection mechanism, the load sensor, and the motor. The controller is configured to receive a mode selection signal from the mode selection mechanism, drive, in response to the mode selection signal indicating the selection of either the first clutch threshold or the second clutch threshold, the motor, receive a load signal from the load sensor related to the load of the motor, determine a load level of the motor based upon the load signal, and activate the electronic clutch when the load level of the motor is greater than or equal to the selected first clutch threshold or the second clutch threshold.

Methods described herein provide for controlling an impact mechanism of a power tool. The methods include selecting, by a controller including an electronic processor, via a mode selection mechanism, an electronic clutch mode, the electronic clutch mode including an electronic clutch threshold, driving, in response to selection of the clutch mode, a motor, receiving, via a load sensor, a load signal related to a load of a motor, determining, by the controller, the load of the motor based on the load signal, and activating, by the controller, the electronic clutch when the load level of the motor is greater than or equal to the electronic clutch threshold.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a power tool according to embodiments described herein.

FIG. 2 is a block diagram of the power tool of FIG. 1.

FIG. 3 is a side view of an impact mechanism of the power tool of FIG. 1.

FIG. 4A illustrates a dial switch for controlling a clutch setting, according to embodiments described herein.

FIG. 4B illustrates a rocker switch for controlling a clutch setting, according to embodiments described herein.

FIG. 5A is a flow chart illustrating an electronic clutch control process, according to embodiments described herein.

FIG. 5B is a flow chart illustrating an electronic clutch control process, according to embodiments described herein.

### DETAILED DESCRIPTION

Embodiments described herein relate to a power tool for driving fastening devices into a workpiece. The power tool can be, for example, an impact tool (e.g., an impact driver, an impact wrench, a hammer drill, etc.) that includes an impact mechanism. The impact mechanism includes a hammer, a spring associated with the hammer, and an anvil. The impact tool also includes an electronic clutch. The electronic clutch may be used, for example, to accurately control the application of torque to a fastener during a fastening operation. In some embodiments, the electronic clutch includes a torque threshold set by a user of the power tool. The use of an electronic clutch in the impact tool advantageously allows for greater control during low torque fastening applications. Impact tools can produce too much torque for certain applications (e.g., deck screws, cabinet screws, etc.). In such instances, the impact tool can overdrive the fastener before a user is able to react. By implementing the electronic clutch in the impact tool for low torque applications, a user of the power tool is able to drive a fastening device accurately and quickly into a workpiece while being able to trust that the fastening device will stop when flush with the surface of the workpiece and not be overdriven. The clutch threshold used by the electronic clutch is set to a value lower than a trip torque value of the impact mechanism. For example a trip torque value may be a point at which the motor becomes decoupled from the drive train and the impact mechanism enters an impacting state. The trip torque value itself may be predetermined for the impact mechanism, or tuned based upon additional factors such as a stiffness level of a spring, a preload level of the spring, a cam shaft groove geometry (e.g., an elevation angle), or the like. In some embodiments detailed herein, a combination of factors may contribute to a specific trip torque value or a trip torque setting. In some instances, a higher trip torque may be tuned for higher torque applications (e.g., lag bolts, ledgerloks, etc.). In some embodiments, by increasing the trip torque value, the length of the impact mechanism, and therefore the length of the power tool, can be shortened. In some instances, the electronic clutch settings may include a plurality of clutch settings for setting and selecting different clutch set points. For example, as described in greater detail below, a user of the power tool may select a clutch mode and a clutch setting based upon expected work load levels.

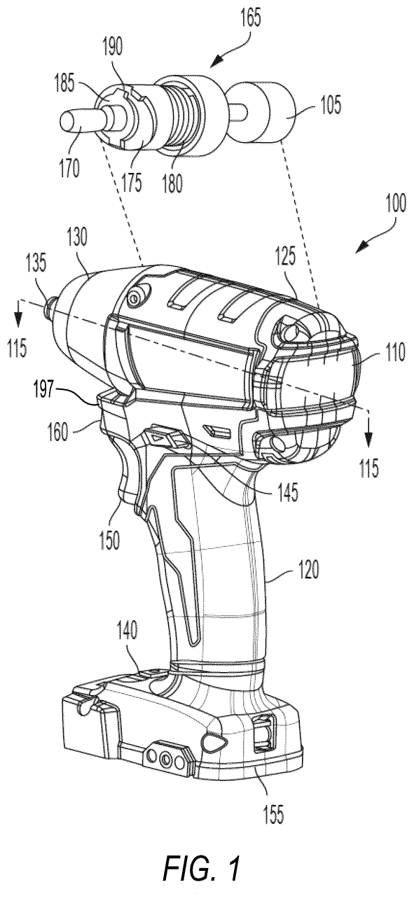

FIG. 1 illustrates a power tool 100 including a brushless direct current (“BLDC”) motor 105. In a brushless motor power tool, such as power tool 100, switching elements are selectively enabled and disabled by control signals from a controller to selectively apply power from a power source (e.g., battery pack) to drive (e.g., control) a brushless motor. In some embodiments, the power tool 100 is a brushless impact wrench having a housing 110 with a central axis 115, a handle portion 120, and a motor housing portion 125. The motor housing portion 125 is mechanically coupled to an impact case 130 that houses an output unit 135. The impact case 130 forms a nose of the power tool 100, and can be made from a different material than the housing 110. For example, the impact case 130 may be metal, while the housing 110 may be plastic. The power tool 100 further includes a mode select button 140, a forward/reverse selector 145, a trigger 150, a battery interface 155, and a light 160. Although the power tool 100 illustrated in FIG. 1 is an impact wrench, the power tool 100 can also be a different type of tool, such as, for example, a hammer drill, an impact hole saw, an impact driver, or the like.

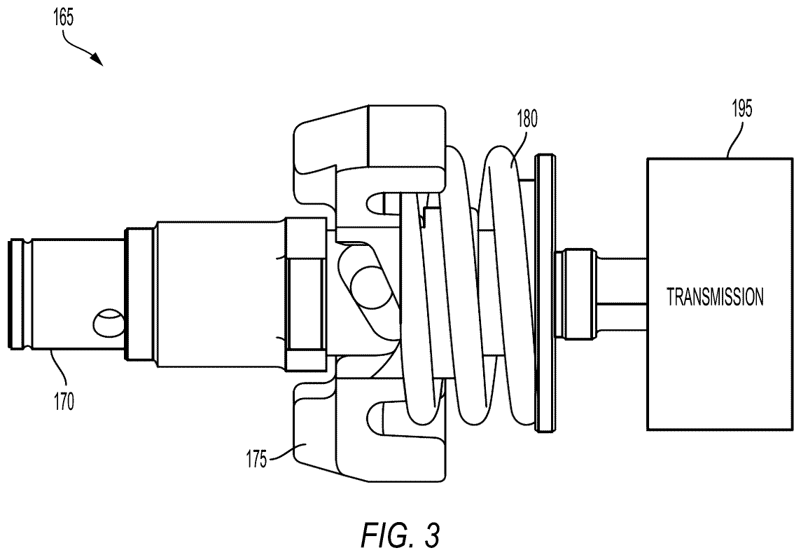

The power tool 100 also includes an impact mechanism 165 including an anvil 170, and a hammer 175. The impact mechanism 165 is positioned within the impact case 130 and is mechanically coupled to the motor 105 via a transmission 195 (see FIG. 3). The transmission 195 may include, for example, gears or other mechanisms to transfer the rotational power from the motor 105 to the impact mechanism 165, and in particular, to the hammer 175. The hammer 175 is axially biased to engage the anvil 170 via a spring 180. The hammer 175 impacts the anvil 170 periodically to increase the amount of torque delivered by the power tool 100 (e.g., the anvil 170 drives the output unit 135). The anvil 170 includes an engagement structure 185 that is rotationally fixed with portions of the anvil 170. The engagement structure 185 includes a plurality of protrusions 190 (e.g., two protrusions in the illustrated embodiment) to engage the hammer 175 and receive the impact from the hammer 175.

During an impacting event or cycle, as the motor 105 continues to rotate, the power tool 100 encounters a higher resistance and winds up the spring 180 coupled to the hammer 175. As the spring 180 compresses, the spring 180 retracts toward the motor 105, pulling along the hammer 175 until the hammer 175 disengages from the anvil 170 and surges forward to strike and re-engage the anvil 170. In some embodiments, the spring 180 includes a tension (e.g., a spring stiffness) that is related to a trip torque value (also referred to as a trip torque threshold) of the impact mechanism 165. For example, the trip torque value may be a certain torque at which the power tool causes an impact event. An impact event refers to the moment in which the spring 180 releases and the hammer 175 strikes the anvil 170. The impacts increase the amount of torque delivered by the anvil 170.

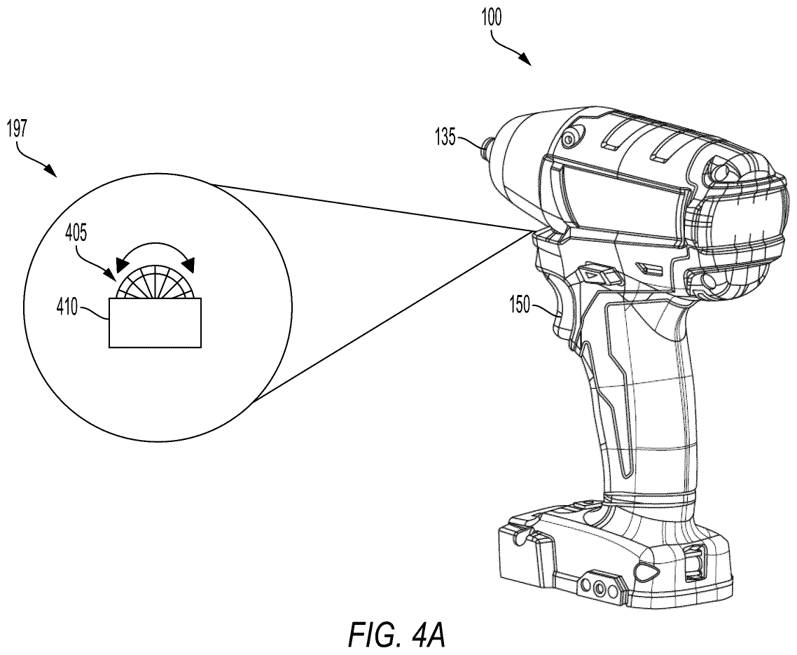

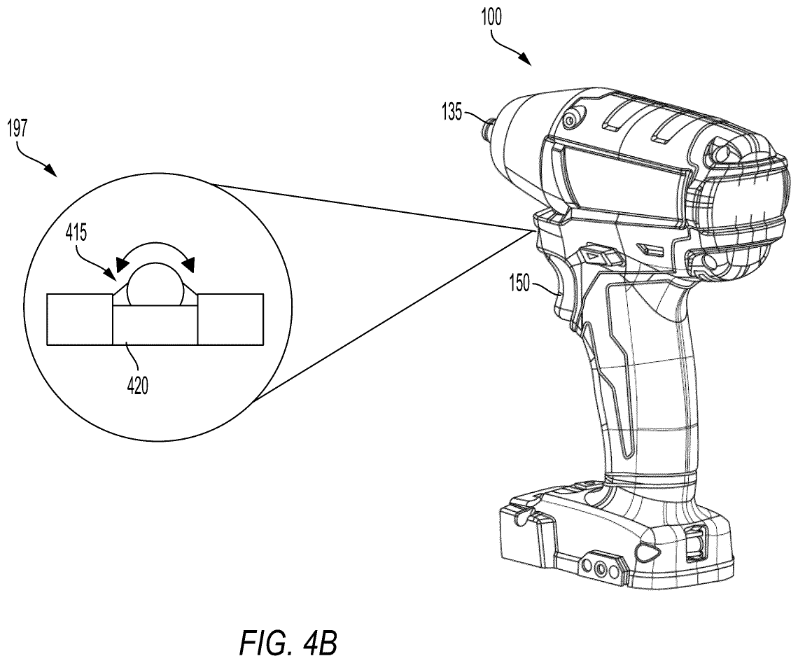

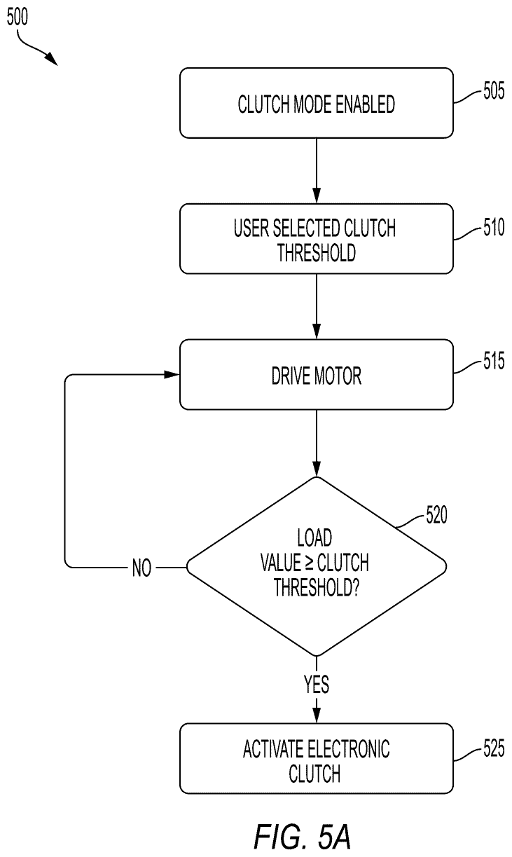

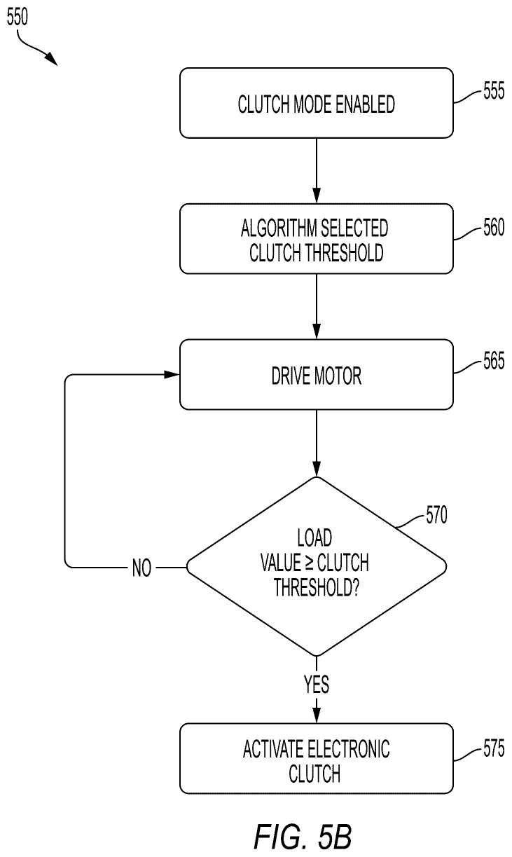

The power tool also includes an input or a switch 197 for selecting between an impact mode, as described above, and a clutch mode. Clutch mode enables an electronic clutch of the power tool 100. The electronic clutch has a clutch setting (also referred to as a clutch threshold or clutch load threshold). The clutch setting corresponds to a desired torque output (or current output) for the power tool 100. Once the clutch load setting is reached or exceeded, the power tool 100 activates the electronic clutch (e.g., to brake or stop driving the motor 105). In some embodiments, the clutch setting has a threshold that is less than the torque trip value of the spring 180 to ensure that impacting does not occur while in the clutch mode. For example, when the power tool 100 is selected to operate in the clutch mode and the spring has a high torque trip value, the impact mechanism 165 is prevented from impacting. The operation of the electronic clutch is further illustrated in FIG. 5A and FIG. 5B. In some embodiments, the clutch load setting is set by the switch 197. The switch 197 is further illustrated in FIG. 4A and FIG. 4B. The clutch setting may also be set in other ways, such as being communicated to the power tool 100 from an external device. In some embodiments, clutch mode or a specific clutch load setting is controlled by a machine learning algorithm.

Additionally, the clutch setting may include more than one clutch setting or clutch threshold. In some embodiments, the clutch may include a plurality of clutch settings or clutch thresholds. For example, once a clutch setting is selected by the user, the user may select a higher clutch setting or threshold or a lower clutch setting or threshold using, for example, the switch 197. The switch 197 may include a plurality of setpoints, where each of the setpoints is associated with one of the plurality of clutch thresholds. For example, when the power tool 100 is selected to operate in a high torque mode or operation, a high clutch setting can be selected (e.g., a clutch setting that is greater than the trip torque of the impact mechanism 165). When the power tool 100 is selected to operate in a low torque mode of operation, a low clutch setting can be selected (e.g., a clutch setting that is less than the trip torque of the impact mechanism 165). In such low torque operations, the impact mechanism 165 is prevented from impacting before the low clutch setting is reached. The switch 197 is described in further detail below.

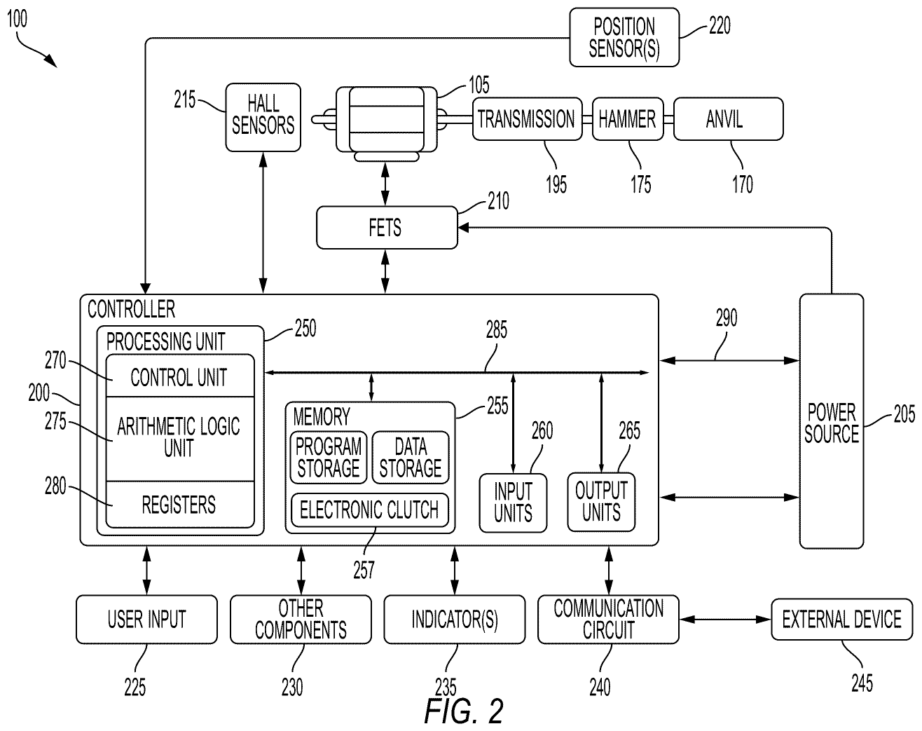

FIG. 2 illustrates an electromechanical diagram of the power tool 100, which includes a controller 200. The controller 200 is electrically and/or communicatively connected to a variety of modules or components of the power tool 100. For example, the illustrated controller 200 is connected to a power source 205 (e.g., a power tool battery pack), field effect transistors (“FETs”) 210, the motor 105, Hall effect sensors 215 (also referred to as Hall sensors), one or more position sensors 220, a user input 225, other components 230 (e.g., a battery pack fuel gauge, work lights [e.g., LEDs], current/voltage sensors, etc.), one or more indicators 235 (e.g., LEDs), and a communication circuit 240 (e.g., a transceiver or a wired interface) configured to communicate with an external device 245 (e.g., a smartphone, a tablet computer, a laptop computer, and the like).

The controller 200 includes combinations of hardware and software that are operable to, among other things, control the operation of the power tool 100, detect linear and/or rotational positions associated with the impact mechanism 165, control power provided to the motor 105, etc. In some embodiments, the controller 200 includes a plurality of electrical and electronic components that provide power, operational control, and protection to the components and modules within the controller 200 and/or power tool 100. For example, the controller 200 includes, among other things, a processing unit 250 (e.g., a microprocessor, a microcontroller, or another suitable programmable device), a memory 255, input units 260, and output units 265. The processing unit 250 includes, among other things, a control unit 270, an arithmetic logic unit (“ALU”) 275, and a plurality of registers 280 (shown as a group of registers in FIG. 2), and is implemented using a known computer architecture (e.g., a modified Harvard architecture, a von Neumann architecture, etc.). The processing unit 250, the memory 255, the input units 260, and the output units 265, as well as the various modules connected to the controller 200 are connected by one or more control and/or data buses (e.g., common bus 285). The control and/or data buses are shown generally in FIG. 2 for illustrative purposes. The use of one or more control and/or data buses for the interconnection between and communication among the various modules and components would be known to a person skilled in the art in view of the invention described herein.

The memory 255 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 250 is connected to the memory 255 and executes software instructions that are capable of being stored in a RAM of the memory 255 (e.g., during execution), a ROM of the memory 255 (e.g., on a generally permanent basis), or another non-transitory computer readable medium such as another memory or a disc. Software included in the implementation of the power tool 100 can be stored in the memory 255 of the controller 200. The software includes, for example, firmware, one or more applications, program data, filters, rules, one or more program modules, and other executable instructions. The controller 200 is configured to retrieve from memory and execute, among other things, instructions related to the control of the power tool 100 described herein. In other constructions, the controller 200 includes additional, fewer, or different components.

The memory 255 of the controller 200 can also include data and instructions related to the implementation of an electronic clutch 257 (e.g., one or more torque or current threshold values, instructions for controlling the motor 105, etc.). The electronic clutch 257 operates similarly to a mechanical clutch without the need for the components of a mechanical clutch (e.g., by monitoring a torque and/or a current associated with the motor 105). The operation process of the mechanical clutch is illustrated in FIG. 5A and FIG. 5B.

The power source 205 provides DC power to the various components of the power tool 100. In some embodiments, the power source 205 is a power tool battery pack that is rechargeable and includes, for example, lithium ion battery cells. In other embodiments, the power source 205 may receive AC power (e.g., 120V/60 Hz) from a tool plug that is coupled to a standard wall outlet, and then filter, condition, and rectify the received power to output DC power. In some embodiments, the power tool 100 includes, for example, a communication line 290 for providing a communication line or link between the controller 200 and the power source 205.

Each of the Hall sensors 215 outputs motor feedback information, such as an indication (e.g., a signal or a pulse) related to when a magnet of the motor 105's rotor rotates across the face of that Hall sensor 215. Based on the motor feedback information from the Hall sensors 215, the controller 200 is able to determine the rotational position, speed, and/or acceleration of the rotor. The one or more position sensors 220 output information regarding the position of, for example, the anvil 170, the hammer 175, the spring 180, etc.

The power tool 100 is configured to operate in various modes. For example, the controller 200 receives user controls from user input 225, such as by selecting an operating mode with the mode select button 140, shifting the forward/reverse selector 145, or depressing the trigger 150. In response to the motor feedback information and user controls, the controller 200 generates control signals to control the FETs 210 to drive the motor 105. By selectively enabling and disabling the FETs 210, power from the power source 205 is selectively applied to stator coils of the motor 105 to cause rotation of the motor 105's rotor. Although not shown explicitly, the one or more position sensors 220 and other components of the power tool 100 are electrically coupled to the power source 205 such that the power source 205 provides power to those components.

In some embodiments, controller 200 also controls other aspects of the power tool 100 such as, for example, operation of the light 160 and/or the fuel gauge, recording usage data, communication with an external device, and the like. In some embodiments, the power tool 100 is configured to control the operation of the motor based on the number of impacts executed by the hammer 175 of the power tool 100. For example, in some embodiments, the controller 200 is configured to monitor a change in position, speed, and/or acceleration associated with the impact mechanism 165 to detect the number of impacts executed by the power tool 100. The controller 200 can then control the motor 105 based on the detected number of impacts. By monitoring the impact mechanism 165, the controller 200 can effectively control, for example, the number of impacts over the entire range of the tool's battery charge and motor speeds (i.e., regardless of the battery charge or the motor speed).

As previously described, the power tool 100 may include a plurality of clutch settings or clutch setting values, where each of the plurality of clutch settings is associated with a different load value for the motor. In some instances, the motor load value is determined by measuring parameters that indirectly indicate the load on the motor 105. For example, one or more current sensors may be configured to actively measure the current of the motor 105, one or more speed sensors may be configured to actively measure the speed of the motor 105, one or more torque sensors may be configured to actively measure the torque of the motor 105, etc. The sensor or sensors that are used to monitor a load of the motor can collectively be referred to as a load sensor, which can include multiple sensors. Additionally, the load sensor can receive or generate a plurality of signals related to the load of the motor that are collectively referred to as a load signal. As the load on a motor 105 increases, the motor 105 draws, for example, a greater amount of current from the power source 205. In some instances, the load level of the motor 105 is determined by additional factors, such as by including the measured speed of the motor 105 using the Hall effect sensors 215, a torque of the motor 105, etc., as previously described. A combination of the current measurement and the speed measurement enables the electronic clutch to accurately associate a load level of the motor 105 with one or more of the plurality of clutch settings or clutch setting values. In some embodiments, the load sensor is a current sensor configured to sense a current through the motor 105.

FIG. 3 is an isolated side view of the impact mechanism 165 coupled to the transmission 195 for driving the impact mechanism 165. The one or more position sensors 220 can be associated with the various portions of the impact mechanism 165 to detect one or more characteristics or attributes of the impact mechanism 165. The characteristics of the impact mechanism include, for example, linear position of the hammer 175, linear position of the spring 180 (e.g., a compression state of the spring 180), rotational position of the hammer 175, direction of rotation of the hammer 175, rotational position of the anvil 170, etc.

In some embodiments, the spring 180 is designed with a spring stiffness that generally corresponds to a high trip torque value for the impact mechanism 165. A trip torque value is the torque required to compress the spring 180 to create impacts between the hammer 175 and the anvil 170. Impacting is desirable, for example, to drive a heavy-duty fastening device (e.g., a lag bolt, lag screw, or the like) into a workpiece. In contrast to a high trip torque value, a lower trip torque value may be associated with driving a light-duty fastening device (e.g., a wood screw, drywall screw, sheet metal screw, or the like). In other embodiments, a high trip torque value may be associated with distinct fastening devices, specific torques in Newton-meters (or pound-foot, inch-pound, or the like), particular workpieces, or the like. During operation of the power tool 100, when the trip torque is exceeded, the impact mechanism 165 will cause an impact event. If the trip torque is not exceeded, the motor 105 will rotate but the impact mechanism 165 will not cause an impact event (i.e., the hammer 175 will rotate with the anvil 170). In instances where the power tool 100 includes a tunable trip torque, the user of the power tool 100 may select a desired trip torque level using a user input, such as the switch 197, via a clutch collar, or the like. In other embodiments, the trip torque is a static value and different clutch settings can be selected in relation to the trip torque. The desired clutch setting may also be selected by the external device 245 and communicated to the power tool 100 via the communication circuit 240. In this way, the user may tune the electronic clutch to a desired clutch setting specific to the application of the power tool 100.

FIG. 4A and FIG. 4B illustrate the input or the switch 197 for controlling a clutch setting for an electronic clutch of the power tool 100. In some embodiments, the power tool 100 includes the switch 197 for enabling or selecting an electronic clutch mode. The switch 197 generates a mode selection signal indicating a mode of the power tool, including a first mode (e.g., a clutch mode) and a second mode (e.g., an impact mode). The switch 197 may be configured as a dial or rotary switch, such as the dial 405 illustrated in FIG. 4A. In some embodiments, the dial 405 is mounted below the output unit 135 and above the trigger 150 of the power tool 100, within a switch housing 410. The switch housing 410 is configured to mechanically hold the dial 405 and may also be configured to prevent the dial from rotating beyond a certain rotation range. For example, the housing may be configured to allow the dial to rotate no more than a total of 270 degrees. In other embodiments, the switch housing 410 may allow a free range of motion for the dial 405.

The dial 405 is configured to rotate around a central axis and may include one or more clutch torque settings. For example, in some embodiments, rotation of the dial 405 in a fully counterclockwise direction corresponds with the lowest clutch torque setting. The dial 405 may include incremental increases to the clutch torque setting, such that rotation of the dial 405 away from the lowest clutch torque setting incrementally increases a clutch torque threshold. For example, rotation of the dial rotation of the dial 405 in a clockwise direction may increase the clutch torque threshold. In some embodiments, the highest clutch torque setting is equal to or less than the trip torque of the impact mechanism 165, ensuring that the impact mechanism of the power tool 100 will not begin impacting while in the clutch mode.

The dial 405 may be configured with multiple clutch torque set points. For example, when the dial 304 includes 4 clutch settings, rotating the dial 405 clockwise by 90 degrees will increment the clutch torque threshold to the next highest clutch torque set point. In some embodiments, there is a single clutch torque set point and any other positions of the dial 405 correspond to impacting modes of operation for the power tool 100. In other embodiments, there are more than 4 clutch settings. The dial 405 may also be configured to incrementally increase the clutch setting by rotating in the counterclockwise direction. In some embodiments, the dial 405 is additionally configured to select between the first mode (e.g., the clutch mode) and the second mode (e.g., the impact mode). In some embodiments, the dial 405 is located at another location on the power tool 100.

In some embodiments, the switch 197 may be configured as a two-position switch 415 (e.g., a rocker switch), as illustrated in FIG. 4B. The rocker switch 415 includes a switch housing 420 configured to mechanically hold the rocker switch 415. In some embodiments, the rocker switch 415 is located below the output unit 135 and above the trigger 150 of the power tool 100, within a switch housing 420. The rocker switch 415 includes multiple clutch setpoints. For example, in some embodiments, the rocker switch 415 includes a first position for selecting the first mode (e.g., the electronic clutch mode) and a second position for selecting the second mode (e.g., the impact mode).

Ha 5A is a flow chart illustrating an electronic clutch control process 500, according to some embodiments. The process 500 for controlling the electronic clutch begins with step 505, where the clutch mode is enabled. The clutch mode may be enabled, for example, by the switch 197. The process includes step 510, where the controller 200 receives a user selected clutch threshold setting. In some embodiments, the user selected clutch threshold setting is set by the switch 197 based on a position of the dial 405. In other embodiments, a user selected clutch threshold may be communicated to the controller by an external device, such as external device 245. In some embodiments, the clutch threshold setting is predetermined at stored in the memory 255, and is active whenever the electronic clutch mode is selected. Once the controller 200 has received the clutch threshold setting, the process 500 proceeds to step 515, where the controller drives the motor 105. The controller 200 continues to drive the motor 105 while monitoring a load value (e.g., torque, current, speed, etc.) of the motor 105.

In some embodiments, the controller 200 monitors the load value of the motor by receiving a current of the motor 105 from a current sensor, where a specific current value may be associated with a specific load value. For example, a current value of 10 Amperes may be associated with a first load value, and a current value of 20 Amperes may be associated with a second load value. During operation of the motor 105, the controller 200 evaluates the load value. At step 520 of the process 500, the controller 200 compares the load value to the clutch threshold. If the load value is greater than or equal to the clutch threshold, the controller 200 activates the electronic clutch (e.g., to brake and/or stop the driving of the motor 105) at step 525 of the process 500. If the load value is not greater than or equal to the clutch threshold, the controller 200 continues driving the motor 105, returning to step 515 of the process 500.

In some examples, as previously described, the controller 200 monitors the load value by using other sensors in addition to or instead of the current sensor. For example, the measured speed of the motor 105 may be obtained by the Hall effect sensors 215, as previously described. The controller 200 may then use the combination of the current measurement and the speed measurement to determine the load level of the motor 105. The controller 200 may also use the speed of the motor 105 and the current of the motor to determine which trip torque threshold the motor is approaching. For example, the controller 200 may continuously calculate the load level of the motor 105 in order to determine if the load level is increasing or decreasing. Once the controller 200 has determined the present load level of the motor 105, the controller may compare the load level to the trip torque threshold (or the plurality of trip torque thresholds). In some instances, the power tool 100 provides an indication that the load level of the motor 105 is nearing the selected trip torque threshold. For instance, the power tool may provide an indication to the user, via the indicators 235, that the load level of the motor is at or near the selected trip torque threshold.

FIG. 5B is a flow chart illustrating an electronic clutch control process according to some embodiments. The process 550 is similar to process 500 and begins when the clutch mode is enabled at step 555. In some embodiments, clutch mode is enabled by the switch 197 or in another manner, similar to process 500. In some embodiments, the clutch mode is enabled by a machine learning algorithm that is running on the processing unit 250 of the controller 200. For example, during operation of the power tool 100, the machine learning algorithm may determine that a clutch mode should be enabled. The controller 200 will then enable the clutch mode and perform the process 550. The process 550 includes step 560, where the machine learning algorithm selects a clutch threshold.

The clutch threshold selected by the machine learning algorithm is similar to one selected by a user of the power tool 100 (e.g., the clutch threshold is less than the trip torque threshold of the spring 180). In some embodiments, the machine learning algorithm selects a clutch threshold based upon an average amount of current sensed by a current sensor, or a spike of current sensed by the current sensor. In some embodiments, the controller 200 monitors when the trigger 150 is released and correlates current sensed by the current sensor to the release of the trigger 150. The machine learning algorithm then sets the clutch threshold to the appropriate load value associated with the correlated current. The process 550 includes step 565, where the controller 200 drives the motor 105. During operation of the motor 105, the controller 200 evaluates the load value. At step 570 of the process 550, the controller 200 compares the load value to the clutch threshold. If the load value is greater than or equal to the clutch threshold, the controller 200 activates the electronic clutch (e.g., to brake and/or stop the driving of the motor 105) at step 575. If the load value is not greater than or equal to the clutch threshold, the controller 200 continues driving the motor 105, returning to step 565 of the process 550.

Thus, embodiments described herein provide, among other things, techniques for detecting or determining a position of a component in a power tool and controlling the operation of the power tool based on the detected or determined position of the component. Various features and advantages are set forth in the following claims.

What is claimed is:

1. A power tool comprising:
a motor;
an impact mechanism coupled to the motor, the impact mechanism including:
a hammer driven by the motor,
an anvil configured to receive an impact from the hammer, and
a spring within the impact mechanism, the spring configured to axially bias the hammer to engage the anvil, the spring having a spring stiffness related to a trip torque value of the impact mechanism;
a mode selection mechanism configured to select between an electronic clutch mode and an impact mode, the electronic clutch mode including an electronic clutch threshold for activating an electronic clutch, the electronic clutch threshold being less than the trip torque value of the impact mechanism;
a load sensor configured to detect a load of the motor; and
a controller connected to the mode selection mechanism, the load sensor, and the motor, the controller configured to:
receive a mode selection signal from the mode selection mechanism,
drive, in response to the mode selection signal indicating the electronic clutch mode, the motor based on the electronic clutch threshold,
receive a load signal from the load sensor related to the load of the motor, and
activate the electronic clutch when the load of the motor is greater than or equal to the electronic clutch threshold.

2. The power tool of claim 1, wherein the mode selection mechanism is a machine learning algorithm.

3. The power tool of claim 1, wherein the controller is further configured to:
receive, from an external device, the mode selection signal indicating a selection of a first clutch threshold or a second clutch threshold.

4. The power tool of claim 1, wherein the mode selection mechanism is a switch.

5. The power tool of claim 4, wherein the switch is configured to increase the electronic clutch threshold.

6. The power tool of claim 4, wherein the switch is a rocker switch.

7. The power tool of claim 4, wherein the switch is a dial configured to select among a plurality of electronic clutch thresholds.

8. The power tool of claim 7, wherein the dial is configured to rotate in a first direction, and wherein a rotation of the dial in the first direction will increment the electronic clutch threshold among the plurality of electronic clutch thresholds.

9. The power tool of claim 8, wherein the dial is configured to rotate no more than a total of 270 degrees in the first direction.

10. A power tool comprising:
a motor;
an impact mechanism coupled to the motor, the impact mechanism including:
a hammer driven by the motor,
an anvil configured to receive an impact from the hammer, and
a spring within the impact mechanism, the spring configured to axially bias the hammer to engage the anvil, the impact mechanism including a trip torque value;
a mode selection mechanism configured to select a between a first clutch threshold and a second clutch threshold, the first clutch threshold being less than the trip torque value and the second clutch threshold being greater than the trip torque value;
a load sensor configured to detect a load of the motor;
a controller connected to the mode selection mechanism, the load sensor, and the motor, the controller configured to:
receive a mode selection signal from the mode selection mechanism,
drive, in response to the mode selection signal indicating a selection of either the first clutch threshold or the second clutch threshold, the motor,
receive a load signal from the load sensor related to the load of the motor,
determine a load level of the motor based upon the load signal, and
activate an electronic clutch when the load level of the motor is greater than or equal to the selected first clutch threshold or the second clutch threshold.

11. The power tool of claim 10, wherein the mode selection mechanism is a machine learning algorithm.

12. The power tool of claim 10, wherein the controller is further configured to:
receive, from an external device, the mode selection signal indicating a selection of the first clutch threshold or the second clutch threshold.

13. The power tool of claim 10, wherein the mode selection mechanism is a switch.

14. The power tool of claim 13, wherein the switch is configured to increase an electronic clutch threshold.

15. A method of controlling an impact mechanism of a power tool, the method comprising:
selecting, by a controller including an electronic processor, via a mode selection mechanism, an electronic clutch mode, the electronic clutch mode including an electronic clutch threshold;
driving, in response to selection of the clutch mode, a motor;
receiving, via a load sensor, a load signal related to a load of the motor;
determining, by the controller, the load of the motor based on the load signal; and
activating, by the controller, an electronic clutch when the of the motor is greater than or equal to the electronic clutch threshold.

16. The method of claim 15, wherein the mode selection mechanism is a machine learning algorithm.

17. The method of claim 15, the method further comprising:
receiving, via a position sensor, a position signal related to a speed of the motor; and
determining, by the controller, the load of the motor based in part on the speed of the motor.

18. The method of claim 15, wherein the mode selection mechanism is a switch.

19. The method of claim 18, wherein the switch is a dial configured to rotate in a first direction, and wherein a rotation of the dial in the first direction will increase the electronic clutch threshold.

20. The method of claim 18, wherein the switch is a rocker switch.
